(19) United States
(12) Patent Application Publication
(10) Pub. No.: US 2004/0176960 A1
(43) Pub. Date: Sep. 9, 2004

(54) Comprehensive spoken language learning system

(76) Inventors: Zeev Shpiro, Ra'anana (IL); Eric Cohen, Ra'anana (IL)

Correspondence Address: David A. Hall, Heller Ehrman White & McAuliffe LLP, 7th Floor, 4350 La Jolla Village Drive, San Diego, CA, 92122-1246, US

(21) Appl. No.: 10/749,996

(22) Filed: Dec. 31, 2003

Related U.S. Application Data
(60) Provisional application No. 60/437,570, filed on Dec. 31, 2002.

(51) Int. Cl. G10L 11/00

(52) U.S. Cl. 704/277

(57) ABSTRACT

Teaching spoken language skills are accomplished with a computer system in which a user utterance is received into a computer system, the user utterance is analyzed according to basic sound units, a comparison is made of the analyzed user utterance and a desired utterance so as to detect any differences between the analyzed and desired utterances, for each of the basic sound units of the analyzed user utterance, any detected differences are identified for corresponding user pronunciation error, and feedback is provided to the user for the comparison.

### REFERENCE TO PRIORITY DOCUMENT

This application claims the benefit of priority of co-pending U.S. Provisional Patent Application Serial No. 60/437,570 entitled “Comprehensive Spoken Language Learning System” filed Dec. 31, 2002. Priority of the filing date is hereby claimed, and the disclosure of the Provisional Patent Application is hereby incorporated by reference.

### TECHNICAL FIELD

This invention relates generally to educational systems and, more particularly, to computer-assisted spoken language instruction.

### BACKGROUND ART

Computers are being used more and more to assist in educational efforts. This is especially true in language skills instruction aimed at teaching vocabulary, grammar, comprehension and pronunciation. Typical language skills instructional materials include printed matter, audio and video-cassettes, multimedia presentations, and Internet-based training. Most Internet applications, however, do not add significant new features, but merely represent the conversion of other materials to a computer-accessible representation.

Some computer-assisted instruction provides spoken language practice and feedback on desired pronunciation. Whenever spoken language is practiced, in most cases the feedback is general in its nature, or is focused on specific pre-defined sound elements of the produced sound. The user is guided by a target word response and a target pronunciation wherein the user imitates a spoken phrase or sound in a target language. The user's overall performance is usually graded on a single scale (average effect) or according to a predefined expected pronunciation error. In some applications the user can select required levels of speaker performance prior to starting the training; i.e. native, non-native or academic, and thereafter user performance will be assessed accordingly.

For typical computer-assisted systems, the user's performance is graded on a word, phrase or text basis with no grading system or corrective feedback for the individual utterance or phoneme spoken by the user. These systems also generally lack the ability to properly identify and provide feedback if the user makes more than one error. Such systems provide feedback that relates to averaged performance that can be misleading in the case of multiple problems or errors with a student's performance. It is generally hoped that the student, by sheer repetition, will become skilled in the proper pronunciation of words and sounds in the target language.

Students may become discouraged and frustrated if the computer system is unable to understand the word or utterance they are saying and therefore cannot provide instruction, or they may become frustrated if the computer system does not provide meaningful feedback. Research efforts have been directed at improving systems' recognition and identification of the phoneme or word the student is attempting to say, and at keeping track of the student's progress through a lesson plan. For example, U.S. Pat. No. 5,487,671 to Shpiro et al. describes such a language instruction system.

Conventional systems do not provide feedback tailored to a user's current spoken performance issue, such as what he or she should do differently to pronounce words better, nor do they provide feedback tailored to the user's problem relating to a particular phoneme or utterance.

Therefore, there is a need for a comprehensive spoken language instruction system that is responsive to a plurality of difficulties being experienced by an individual student and that provides meaningful feedback that includes the identification of the error being made by the student. The present invention fulfills this need.

### DISCLOSURE OF INVENTION

The present invention supports interactive dialogue in which a spoken user input is recorded into a computerized device and then analyzed according to phonetic criteria. The user input is divided into multiple sound units, and the analysis is performed for each of the basic sound units and presented accordingly for each sound unit. The analysis can be performed for portions of utterances that include multiple basic sound units. For example: analysis of an utterance can be performed on the basis of sound units such as phonemes and also for complete words (where each word includes multiple phonemes). This novel approach presents the user with a comprehensive analysis of substantially all the user-produced sounds and significantly enhances the user's ability to understand his or her pronunciation problems.

The analysis results can be presented in different ways. One way is to present results for all the basic sound units comprising the utterance. An alternative approach is a hierarchical presentation, where the user first receives feedback on the pronunciation of the complete utterance (for example: a sentence), then he or she may elect to receive additional information, and the feedback may be presented for all words comprising the sentence. Then he or she may elect to receive additional information on a specific word or words making up the complete utterance, and the feedback may be presented or displayed for all phonemes comprising the selected word. The user may then receive additional information relating to his or her performance for a specific phoneme, such as the identified mistake, or instructions on how to properly produce the specific sound.

The results of the analysis can be presented on a complete scale, grading the user's performance in multiple levels, or can be presented on a specific scale, such as “Native” performance or “Tourist” performance. The required performance level can be selected by either the user or as part of the system set up.

The analysis results can be presented using a high level grading methodology. One aspect of the methodology is to present the results in a complete scale (i.e. several levels). Another aspect is to present a binary (two-level) decision, simply indicating whether the user performance was above or below an acceptable level.

Different types of input signals are supported: the input utterance can be a text string, a sentence, a phrase, a word, a syllable, and so forth. If the input utterance is a word, and if a hierarchical analysis method is selected, the analysis and feedback will be provided first at the word level and then, if and when additional detailed information is requested, for each of the sound units comprising the word, i.e. phoneme, diaphone, and so forth.

A variety of pronunciation errors in the user input can be analyzed and identified. User utterances can be identified as unacceptable and then rejected, or user utterances can be classified as either “Not Good Enough” or as comprising a substitution error. User utterances can be identified as having an error comprising an insertion error or a deletion error. As described further below, these errors relate to the incorrect insertion or deletion of sounds at the beginning, the middle, or the end of words by a user, and typically occur when a native speaker of one language attempts to pronounce a word or phrase in another language.

Errors produced by the user can be analyzed and identified as errors in pronunciation, intonation, and stress. Feedback can be provided that refers to the user's production error in pronunciation, intonation, and stress performance. The intonation analysis can include sentence categories (such as assertions, questions, tag questions, etc.). Each sentence category includes several examples of the same intonation contour type, so that the user can practice intonation patterns with well-defined meaning correlates, rather than individual intonation contours (as is usually the case in other products).

Other features and advantages of the present invention should be apparent from the following description of the preferred embodiment, which illustrates, by way of example, the principles of the invention.

### BRIEF DESCRIPTION OF DRAWINGS

FIG. 1 shows a user making use of a language training system constructed according to the present invention.

FIG. 2 is a flowchart of the software program operation as executed by the system of FIG. 1.

FIG. 3 shows the display screen of the FIG. 1 system providing a prompt for a user to speak a word and thereby provide the system with a user utterance for analysis.

FIG. 4 shows the display screen of the FIG. 1 system providing a prompt for a user to speak a phrase and thereby provide the system with a user utterance for analysis.

FIG. 5 shows a display screen providing evaluative feedback on the user's production of an entire phrase (utterance) where Pronunciation is selected.

FIG. 6 shows a display screen providing evaluative feedback on one word that was mis-produced in the phrase of FIG. 5.

FIG. 7 shows a display screen providing evaluative feedback for the user's performance on stress of a word when Stress is selected.

FIGS. 8, 9, and 10 show display screens providing evaluative feedback for the same user utterance, according to different scales, or skill levels.

FIGS. 11 and 12 show display screens providing corrective feedback for a specific pronunciation error—substitution.

FIGS. 13 and 14 show display screens providing evaluative feedback on the user's production of a word, where the pronunciation error identified is the insertion of an unwarranted basic sound unit.

FIG. 15 shows a display screen providing evaluative feedback on the user's production of a word, where the pronunciation error is deletion of a basic sound unit.

FIG. 16 shows a display screen providing corrective feedback for the user's production error (deletion) illustrated in FIG. 15.

FIG. 17 shows a display screen providing feedback for intonation performance on a declarative sentence when Intonation is selected.

FIG. 18 shows a display screen providing feedback for intonation performance on an interrogative sentence when Intonation is selected.

FIG. 19 shows a display screen providing feedback for massive deviation from the expected utterance, recognized as “garbage”.

FIG. 20 shows a display screen providing feedback for a well-produced utterance.

### DETAILED DESCRIPTION

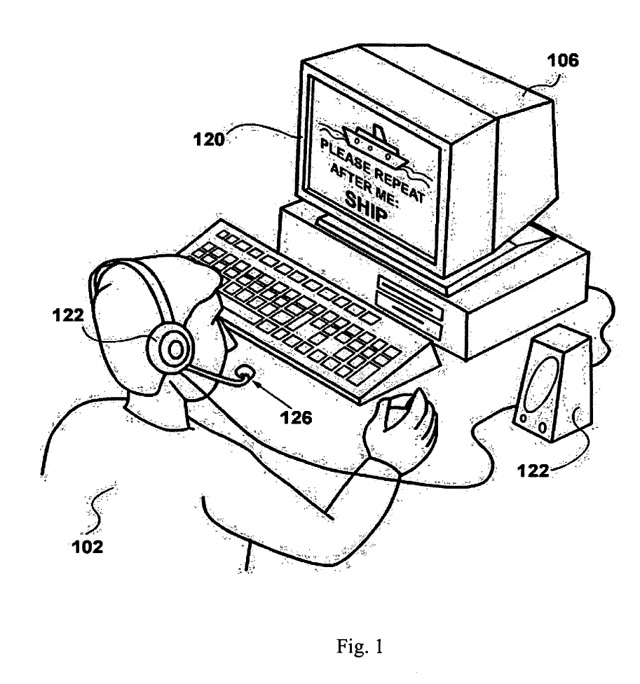

FIG. 1 is a representation of a user 102 making use of a spoken language learning system constructed in accordance with the invention, comprising a personal computer (PC) workstation 106, equipped with sound recording and playback devices. The PC includes a microprocessor that executes program instructions to provide desired operation and functionality. The user 102 views a graphics display 120 of the user computer 106, listening over a headset 122 and providing speech input to the computer by speaking into a microphone input device 126. The computer display 120 shows an image or picture of a ship and a text phrase corresponding to an audio presentation provided to the user: “Please repeat after me: ship.”

A computer-assisted spoken language learning system constructed in accordance with the present invention, such as shown in FIG. 1, can support interactive dialogue with the user and can provide an interactive system that provides exercises that test the user's pronunciation skills. The user provides input to the computer system by speaking an utterance, for example a word or a phrase, into the microphone, thereby providing a user utterance. Whenever the user utterance is received and analyzed, the input utterance is broken down into speech units (also called basic sound units, such as phonemes) and is compared to a target phrase, e.g. a word, expression, or sentence, referred to as the desired utterance.

Feedback is then provided for each of the basic sound units so the user can get a visual presentation of how the user performed on each of the speech segments. Thus, if the user's responses indicate that the user would benefit from extra explanation and/or practice of a particular phoneme, the user will be given corrective feedback relating to that phoneme. The user's responses are preferably graded on one scale or on a number of different scales, for example, on a general language scale and on a specific skill level scale such as “Native” or “Tourist” skill level. The feedback provided to the user relates to the specific utterance within the framework of the specific grade scale selected by the user or set externally.

Systems currently being used generally either present an average grade, which does not provide sufficient information for the user to improve his or her performance, or focus on a specific sound, where the system expects that the user may make a mistake. None of the above-described systems have been successfully accepted by the ESL/EFL teachers community, because they provide either too little or too narrow information to the students and thus prevent them from properly making use of the system's analysis and computational capabilities. The system described herein overcomes these weaknesses by analyzing the input signal (user utterances) in such a way as to provide feedback in a manner that is, on the one hand, general and conclusive, and on the other hand, complete and detailed.

In the FIG. 1 system, the results of the analysis can be presented in a variety of ways where only one or two examples are described and presented in this application. Presenting the results on a complete scale offers multiple, discrete levels (that is, a specific number, such as three levels) of performance assessment; for example: “Unacceptable” performance, “Tourist” level performance, and “Native” level performance. Results that are presented in two levels would be, for example: Acceptable or Unacceptable.

An alternative grading method can be provided by first selecting (by either the user, automatically by the system, or by others) the level of proficiency, and then analyzing the user's performance according to the criteria of the selected level of proficiency. For example, if the Native level is selected, the performance may be graded only as acceptable or unacceptable, but the analysis would be performed according to stringent requirements for native speakers of the target language. By comparison, when the Tourist level is selected, the performance may also be graded as acceptable or unacceptable, but in this case the analysis would be performed according to less strict requirements.

When a user selects an option to receive further information relating to a performance that was classified as unacceptable, he or she will receive a breakdown of the grading for each of the elements comprising the complete sound (the utterance). If the user reaches the level of the basic sound element, the system will provide corrective feedback instructing the user how to properly produce the desired sound, or, when a pronunciation and/or stress and/or intonation error is identified, an even more comprehensive explanation will be provided, detailing what mistake was made by the user and how the user should change his or her pronunciation to correct the identified mistake.

Another feature of the FIG. 1 system is the displaying of the part of text associated with the presented grade adjacent to the grade indicator. When the basic sound elements are phonemes, in a system such as FIG. 1 that targets improved user performance of the basic sound elements as the goal, the phonemes are marked on the display according to conventional phonetic symbols (terminology) that are well-known in the phonetician community. Whereas some software programs include the teaching of some phonetic terminology as part of teaching pronunciation, the FIG. 1 system associates the part of the text that is closest to the graded sound and links it to the grade by, for example, presenting it visually below the grading bar of the display, and marks it with different color on the phrase text.

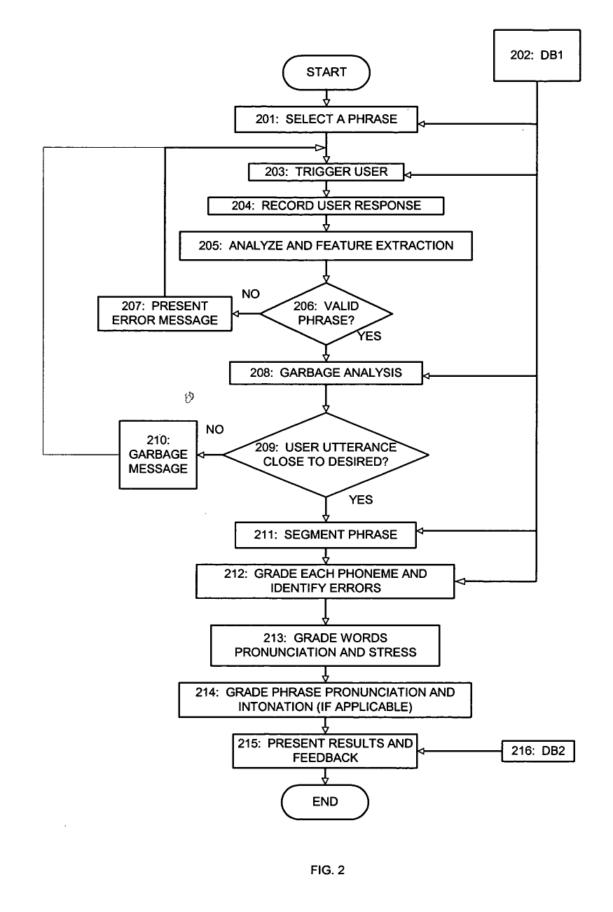

FIG. 2 shows a flow chart that represents operation of the programming for the FIG. 1 computer system. When program instructions are loaded into memory of the FIG. 1 computer system 106 and are executed, the sequence of operations depicted in FIG. 2 will be performed. The program instructions can be loaded, for example, by removable media such as optical (CD) discs read by the PC or through a network interface by downloading over a network connection into the PC.

When a user starts to run the FIG. 1 system, he or she is requested to select a phrase from a list (represented by the FIG. 2 flow chart box numbered 201). This list is prepared in advance of the session and is stored in a database DB1 (represented by the box numbered 202). For each phrase stored in the database DB1, there is an associated text, a picture, a narrated pre-recorded sound track properly producing the spoken phrase, and additional phonetic (Pronunciation, Stress, Intonation etc.) information that is required for the analysis and grading of the phrase in later phases of the process. After the user phrase selection, the system presents a picture associated with the selected phrase, plays the reference sound track, and requests the user to imitate the sound (box 203) by speaking into the system microphone. Then the system receives the spoken input of the user repeating the phrase he or she just heard, and records it (at box 204).

The system next analyzes the user-produced sound for general errors, such as whether the user spoken input was too soft, too high, no speech detected, and so forth (box 205), and extracts the utterance features. If an error was identified (a “No” outcome at box 206), the system presents an error message (box 207) and automatically goes back to the “Trigger User” phase (box 203). It should be noted that this process can be run in parallel to the phonetic analysis. That is, checking for a valid phrase typically involves a higher order analysis than basic sound unit segmentation, which occurs later in the flowchart of FIG. 2. If the “valid phrase” checking is performed in parallel to the phonetic segmentation analysis, then phrase segmentation of the user utterance is not delayed until later in the input analysis, but is performed substantially at the same time as “valid phrase” checking at box 206. Returning to the FIG. 2 flowchart, if the user input signal is a valid one, a “Yes” outcome at box 206, the system further analyzes the user input, checking if the phrase was sufficiently close to the expected sound or if the phrase was significantly different (the “Garbage” analysis at box 208).

If the recorded phrase (the user utterance) is analyzed as “garbage” (i.e., it is significantly diverse from the expected or desired utterance, indicated by box 209), then the system presents an error message (box 210) and automatically goes back to the “Trigger User” phase (box 203). The garbage analysis provides a means for efficiently handling nonsensical user input or gross errors. If the recorded sound is sufficiently similar to the expected sound, the system segments the recorded phrase into basic sound units (box 211), for example according to the expected phrase transcription. In the illustrated embodiment, the basic sound units are phonemes. The basic sound unit can be a basic sound unit of the desired utterance language, or can be a basic sound unit of the user's native language. Alternatively, the whole process of error checking and segmentation into basic sound units can be performed before rejecting the user recording as not valid.

It should be mentioned that the segmentation process can be performed in a plurality of ways, known to persons skilled in the field. In some cases, several segmentation processes will be performed according to different possible transcriptions of the phrase. These transcriptions can be developed based on the expected transcription and various grammar rules. Then each phoneme is graded (box 212). The system can perform this grading process in multiple ways. One grading process technique, for example, is for the system to calculate and compare the “distance” between the analyzed phoneme features and those of the expected phoneme model and the “distance” between the analyzed phoneme features and those of the anti (complementary) model of that sound. Persons skilled in the art will understand how to determine the distance between the analyzed user phoneme features and those of the transcriptions and will understand the complementary models of phonemes.

If a specific identification of error is provided as part of the system features, then the specific identified and expected error models will be incorporated into the distance comparison process. The results or the phonemes are then grouped into words and a grade for a user-spoken word is calculated (box 213). There are various ways to calculate the word grade from the grades of all phonemes that comprise the word. In the exemplary system, the word grade is calculated as the lowest phoneme grade among all phonemes comprising the word being graded. Other alternatives will occur to those skilled in the art.

Thus, in accordance with the invention, a high level grading methodology can be provided. In current systems that provide grades for complete sound units such as words or phrases, the grading is an overall averaging process of the user's performance of the different sound elements comprising the complete sound unit (i.e., phonemes for words and words for phrases). According to this method, a word grading process is a process that averages (summation) the user's pronunciation performance of vowels (e.g. “a”, “e”) and Nasals (e.g. “m”, “n”) of the specific word into one result. In the FIG. 1 system, the grade for a complete sound unit comprising a word or a phrase is the lowest grade of any of the grades of the different sound elements comprising the complete sound. For example, a word grade will be the lowest grade of each of the phonemes comprising the word; a phrase grade will be the lowest grade of each of the words comprising the phrase. Thus, the basic sound units of the user utterance are graded against expected sounds, establishing an a priori expected performance level. This technique, which does not merely summarize performance in different scenarios (such as Vowels and Fricatives) but rather assesses individual portions of performance, is in fact much closer to the way human beings analyze and understand speech, and therefore offers better feedback.

Returning to the FIG. 2 flowchart, the stress of the spoken word is also analyzed. If the phrase is composed of more than one word, then a phrase grade is calculated (box 214) in a similar way. The phrase grade is the lowest word grade among all words comprising the phrase. In addition, intonation (in the case of an expression or a sentence) and stress (for word level analysis) are analyzed as part of the phrase grade processing (box 214). Then, when all results are calculated, the system presents them (box 215) in a hierarchical manner, as was explained above, and will be described further below. As part of the result and feedback presentation, the system presents animated feedback that is stored in a second database DB2 (indicated by the flow diagram box numbered 216).

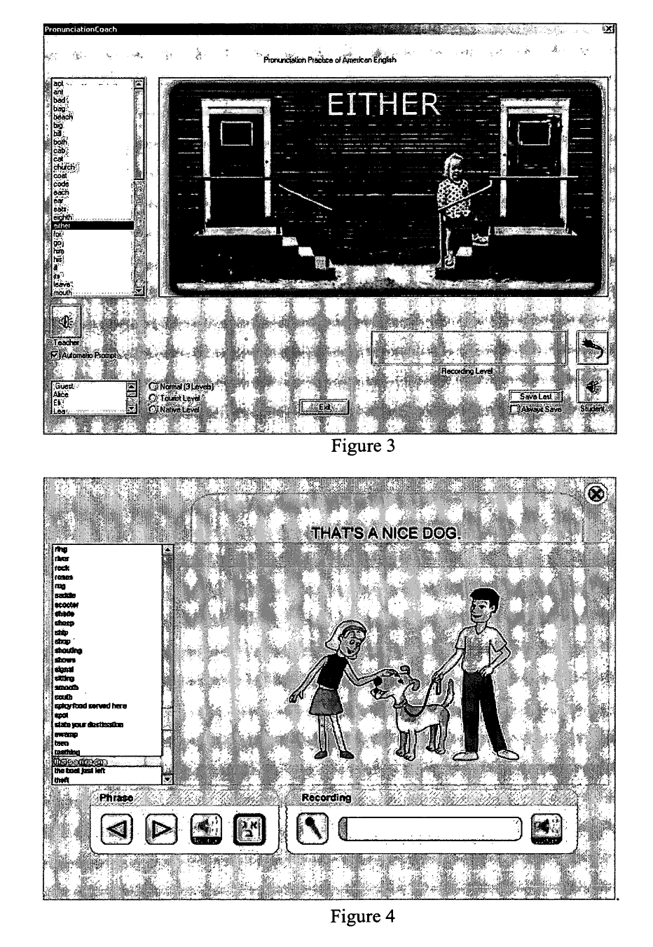

FIG. 3 shows a visual display of the screen triggering the user to speak. The user selects the word to be pronounced by navigating in the left window, and highlighting and selecting a phrase from the list in the window. Then the user selects (by clicking with the display mouse at the box next to the selected level) the speaking level at which the user's pronunciation will be graded. In the illustrated system, there are three levels of speaking level selection: Normal, Tourist, and Native. The text of the user-selected phrase appears on the screen together with a visual representation of the phrase's meaning, and the sound track of the selected phrase is played to the user. The user then presses the “microphone” display button and pronounces the selected phrase, speaking into the microphone device and thereby providing the computer system with a user utterance. The user's utterance is received into the computer of the system through conventional digitizing techniques.

FIG. 4 shows a visual display of a similar screen as in FIG. 3, which triggers the user to speak. In FIG. 3, the selected utterance was a word, whereas in FIG. 4 it is a phrase composed of multiple words. The utterance can be selected either by the user navigating and selecting an utterance in the left display window, or alternatively by clicking on the “Next” and “Previous” display buttons. In the illustrated system, the phrase is randomly selected from the list. The system selection can also be performed non-randomly, e.g. based on analyzing the user pronunciation error profile and selecting a phrase to work on that type of error. The level selection is performed during system set up (i.e. prior to reaching the FIG. 4 display screen). An additional translation display button appears, and when selected by the user, causes the system to present, next to the utterance, its translation of the phrase into the user's native language and also to provide the feedback translated into the user's native language. The other Speaker display buttons enable the user to listen again to the system prompts and to his own utterance, respectively. The Record display button, identified by the microphone symbol, has to be clicked by the user, prior to the user's repetition of the utterance, in order to start the PC recording session.

As noted above, the FIG. 1 system provides feedback on pronunciation and, in addition, provides feedback on intonation performance in the case of user utterances that are phrases or sentences, and on stress performance for user utterances that are words (either independent or part of a sentence). Some phoneticians define “Stress” or “Main Sentence Stress” or similar terms on a sentence level as well as the word level. In order to simplify user interaction, these features are not presented in the following example, but it should be noted that the term “Stress” has broader meaning than for an independent Word.

Pronunciation analysis is offered at all times, and selection between offering the Stress and Intonation options is performed automatically by the system, as a result of the phrase selection (i.e., a word or a phrase). As described further below, the user can select the preferred analysis option by clicking on the appropriate display tab at the top part of the window. The intonation analysis can include sentence categories (such as assertions, questions, tag questions, etc.). Each sentence category comprises several examples of the same intonation contour type, so that the user can practice intonation patterns with well-defined meaning correlates, rather than individual intonation contours (as is usually the case in other products). The user's performance will be matched to a pre-defined pattern and evaluated against the correct pattern. Corrective feedback is given in terms of which part of the phrase requires raising or lowering of pitch. Additional sections provide contrastive focus practice. Contrasts such as “Naomi bought NEW furniture (she did not buy second-hand) vs. “Naomi BOUGHT new furniture” (she did not make it herself) will be practiced in the same way as the categories discussed above. Nonsense intonation (intonation contours that do not match any coherent meaning) is addressed in similar terms of raising or lowering of pitch.

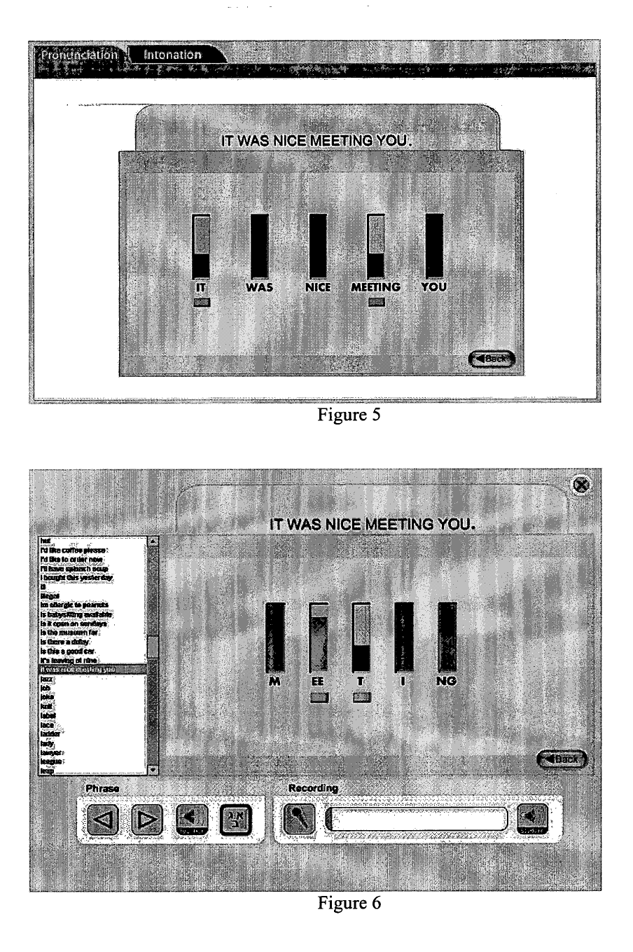

FIG. 5 shows the computer system display screen providing evaluative feedback on the user's production of an input phrase comprising a sentence, showing the entire utterance (i.e. the complete phrase, “It was nice meeting you”) provided in the prompt, when “Pronunciation” is selected. The FIG. 5 display screen appears automatically after the user input is received as a result of the FIG. 4 prompt, and provides the user with a choice between “Pronunciation” and “Intonation” feedback via display tabs shown at the top part of the display. The system can automatically default to showing one or the other selection, and the user has the option of selecting the other, for viewing.

FIG. 5 shows a visual grading display of the screen, grading the user's utterance for each word that makes up the desired utterance. A vertical bar adjacent to each target word indicates whether that word in the desired utterance was pronounced satisfactorily. In the FIG. 5 illustration, the words “it” and “meeting” are indicated as deficient in the spoken phrase. Thus, the user receives feedback indicating whether the user has pronounced the word (or words) of the phrase properly. For any word that was incorrectly pronounced, a display button is added below the bar. When the button is clicked, additional explanations and/or instructions are provided.

FIG. 6 shows a display screen of the computer system that provides evaluative feedback on the user's production of a single mispronounced word (e.g., “meeting”) out of the complete spoken phrase provided in FIG. 5. The FIG. 6 feedback is provided after the user clicks on the display button in FIG. 5 below the graded word “meeting” and is based on phonemes as the basic sound units making up the word. For any mispronounced phoneme, a display button is added below the vertical grading bar. When such a button is clicked, the system provides additional explanations and/or instructions on the user's production errors.

Stress is related to basic sound units, which are usually vowels or syllables. The system analyzes the utterance produced by the user to find the stress level of the produced basic sound units in relation to the stress levels of the desired utterance. For each relevant basic sound unit, the system provides feedback reflecting the differences or similarities in the user's production of stress as compared to the desired performance. The stress levels are defined, for example, as major (primary) stress, minor (secondary) stress, and no stress.

As noted above, the input phrase (desired utterance) may comprise a single word, rather than a phrase or sentence. In the case of a word input, the feedback provided to the user is with respect to the pronunciation performance and to stress performance.

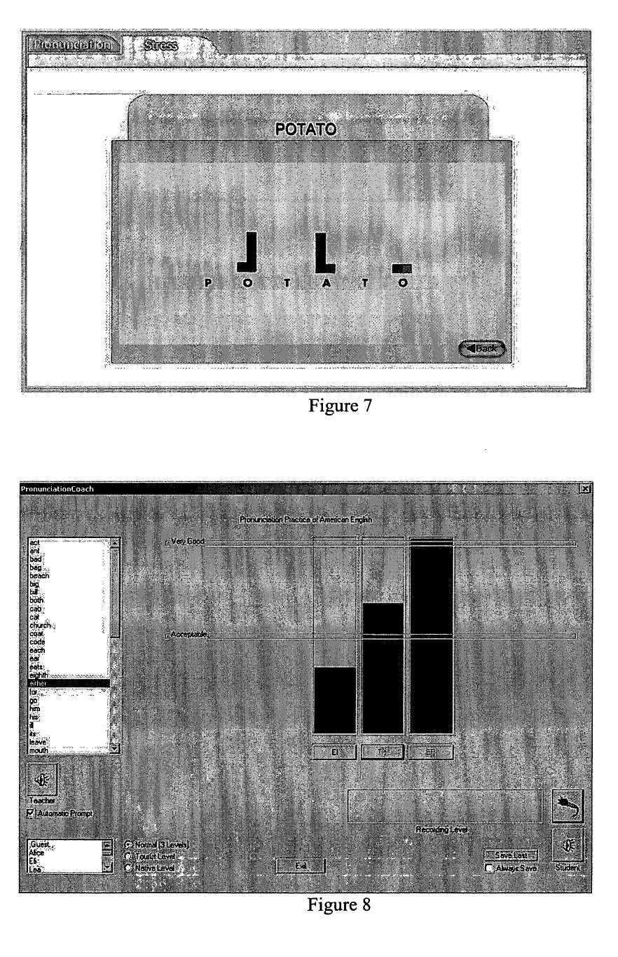

FIG. 7 shows the computer system display screen providing evaluative feedback for the user's production on an input comprising a word, showing the user's performance on stress when the “Stress” display tab is selected for the word feedback. In FIG. 7, a pair of vertical display bars is associated with each phoneme comprising the phonemes in the target word (“potato”). The heights of the vertical bars represent the stress level, where the left-side bar of each pair indicates the desired level of stress and the right-side bar indicates the user-produced stress. The color of the user's performance bar can be used to indicate a binary grade: Green for correct, red for incorrect (that is, an incorrect stress is a stress that was below the desired level).

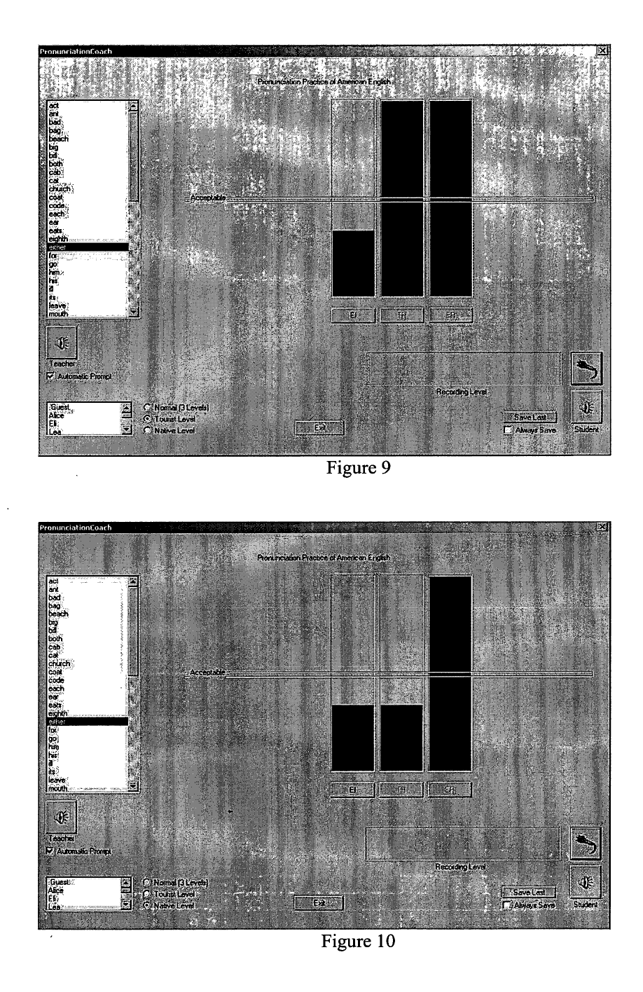

FIGS. 8, 9, and 10 show the display screens providing evaluative feedback for the same user utterance, according to different scales or grading levels. In FIG. 8 the user's performance is scored on a ternary scale, where the scale can consist of any number of values. In FIG. 9, the same user performance is mapped to a binary scale reflecting a “tourist” proficiency level target, while in FIG. 10 the user's performance is mapped to a binary scale reflecting a “native” proficiency level target. Again, the scales can consist of multiple values.

For a three-level grading method, the feedback will indicate whether the user pronounced the phrase on either a very good level, acceptable level, or below acceptable level. This 3-level grading method is the “normal” or “complete” grading level. Below the grading bar, the utterance text is displayed on a display button, as shown in FIGS. 8, 9, and 10, or above a display button. If the user is interested in receiving additional information, he or she clicks on the display button to receive feedback on how the user performed for each of the sounds comprising the utterance, as presented in FIG. 5, described next. As noted above in conjunction with FIG. 2, the data for presentation of feedback is retrieved from the system database DB2.

FIG. 8 shows a visual display of the display window that grades the phoneme pronunciation of the user's utterance on a complete scale. The utterance, a word in the illustrated example, is divided into speaking elements, such as phonemes, and pronunciation grading was performed and provided for each of these speaking units—phonemes. In addition, the part of the text associated with the specific unit appears on a display button below the grading bar. When the user clicks on the button of a phoneme that was pronounced less than “very good”, the user will receive more information on the grading and/or identified error. In addition, the user will receive corrective feedback on how to improve performance and thereby receive a better grade. The received feedback varies, depending on the achieved score and user parameters, such as User Native Language, performance in previous exercises, and the like.

FIG. 9 shows a visual display of the screen presented in FIG. 8, for the same spoken utterance, but in FIG. 9 the grading of the user's phoneme pronunciation is performed on a “tourist” scale, and the grading is binary. That is, there are only two grade levels, either acceptable (above the line) or unacceptable (below the line). It should be noted that this binary grading, when performed according to Tourist level, will “round” the “OK” result (“Acceptable”) for “TH” (as presented in the Normal scale shown in FIG. 8) into the “Acceptable” level (the full height of the vertical bar for “TH” in FIG. 9).

FIG. 10 shows a visual display for a “Native” scale grading that otherwise corresponds to the complete scale grading screen presented in FIG. 8. That is, FIG. 8 and FIG. 10 relate to the same user utterance, but FIG. 10 shows a binary grading of the user's phoneme pronunciation on a “Native” scale, said grading having only two levels, either acceptable (above the line) or unacceptable (below the line). It should be noted that this binary grading, when performed according to the “Native” level, will “round” the “OK” result for “TH” (as presented in Normal scale of FIG. 8) into the “Unacceptable” level in FIG. 10.

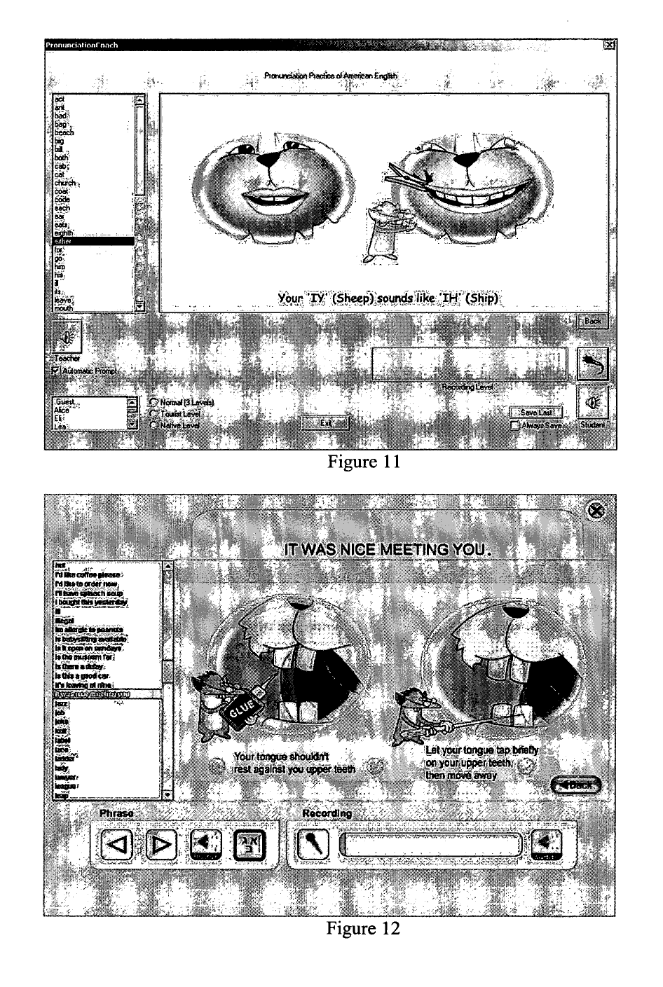

FIG. 11 shows a visual display screen providing feedback for the specific sound “EI”, graded as unacceptable. In this case, the system successfully identified the specific error made by the user in attempting to produce the sound associated with the letter phrase “EI”, called in phonetic language “IY”, and the actual sound produced, called in phonetic language “IH”. The computer display shows an animated image comparing the correct and incorrect pronunciations of the two sounds, together with the error feedback “your ‘iy’ (sheep) sounds like ‘ih’ (ship).” Thus the system instructs the user on what s/he should do, and how s/he should do it, in order to produce the target sound in an acceptable way.

FIG. 12 shows a display screen providing corrective feedback for a specific pronunciation error, based on identification of one or more basic sound units in the user's utterance that deviate from the acceptable pronunciation. The screenshot represents a pair of animated movies: One movie showing the character on the left saying “Your tongue shouldn't rest against your upper teeth”, and the other showing the character on the right saying “Let your tongue tap briefly on your upper teeth, then move away”. This feedback corresponds to a pronunciation of the sound “t” or “d”, where a “flap” sound is desired (a flap is produced by touching the tongue to the tooth ridge and quickly pulling it back). Again, the data for presentation of such feedback is retrieved from the system database DB2.

As noted above, the system analyzes and identifies particular user pronunciation errors that are classified as insertion errors and deletion errors. These types of errors often occur in specific native language speakers as they try to pronounce foreign sounds. More particularly, different languages have their own rules as to which sound sequences are allowed. When a native speaker of one language pronounces a word (or a phrase) in a different language, they sometimes inappropriately apply the rules of their native language to the foreign phrase. When such a speaker encounters a sequence of sounds that is impossible in his/her native language, he/she typically resorts to one of two strategies: either deleting some of the sounds in the sequence, or inserting other sounds to break up the sequence into something that he/she finds manageable.

Several examples will help clarify the above. For example, a common insertion error of Spanish and Portuguese speakers, who have difficulties with the sound “s” followed by another consonant at the beginning of a word, is the insertion of a short vowel sound before the consonant sequence. Thus, “school” often becomes “eschool” in their speech, and “steam” becomes “esteem”.

Another example is that of Italian, Japanese, and Portuguese speakers who tend to have difficulties with most consonants at word endings. Therefore, many of these speakers insert a short vowel sound after the consonant. Thus, “big” sounds like “bigge” when pronounced by some Italian speakers, “biggu” in the speech of many Japanese, and Portuguese speakers often pronounce it as “biggi”.

The Japanese language tolerates very few consonant sequences in any position in the word. For example, “strike” in Japanese typically comes out as “sutoraiku” and “taxi” is pronounced “takushi”.

Deletion is another example of how users may handle a sequence of sounds that is not common in their native language. Italian speakers, for example, may fail to produce the sound “h” appearing in a word initial position, thus a word such as “hill” may be pronounced as “ill”).

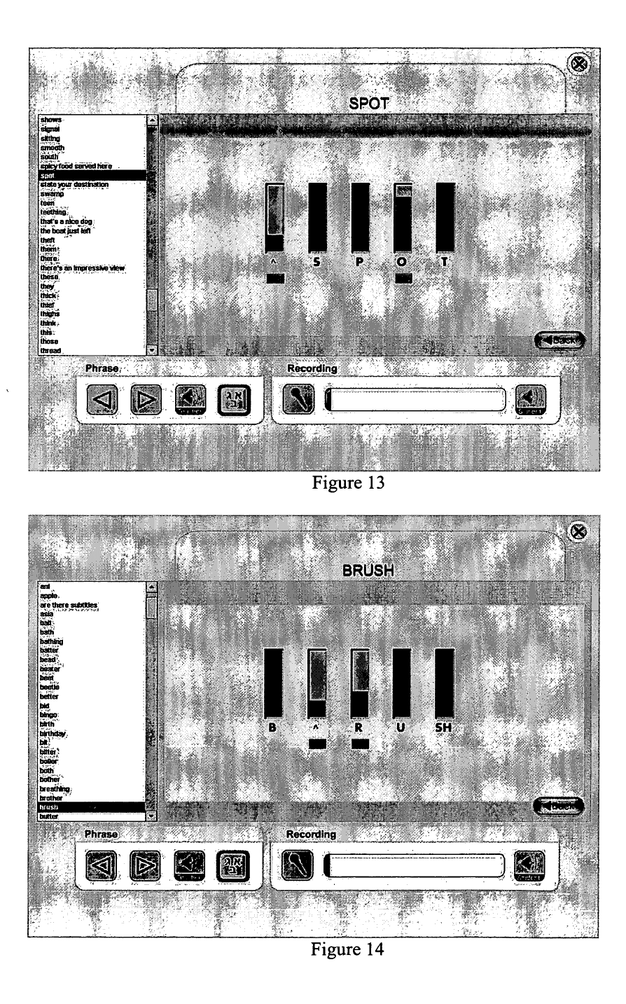

FIGS. 13 and 14 show display screens providing evaluative feedback on the user's production of a word, where the pronunciation error consists of insertion of an unwarranted basic sound unit. The first vertical bar on the left in FIG. 13 corresponds to a vowel that is produced before the sound “s” when pronouncing the word “spot”. The second bar on the left in FIG. 14 corresponds to another vowel insertion between the sounds “b” and “r” when pronouncing the word “brush”.

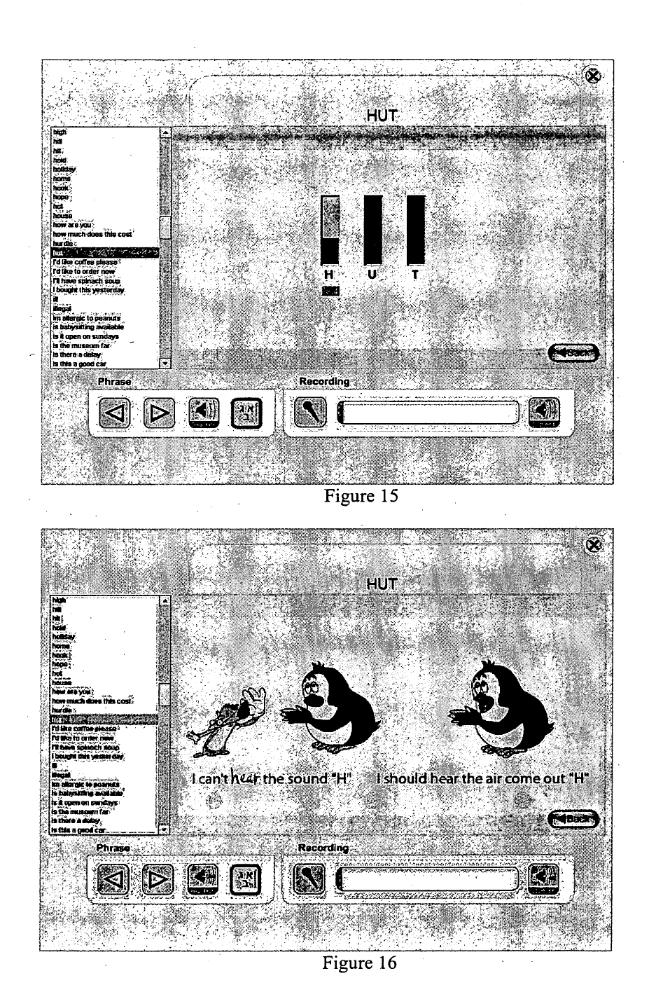

FIG. 15 shows the display screen providing evaluative feedback on the user's production of a word, where the pronunciation error consists of deletion of a basic sound unit. The first bar on the left represents a grade for not producing the sound “h” (the first sound of the word “Hut”).

FIG. 16 shows the display screen providing corrective feedback for the user's production error illustrated in FIG. 15.

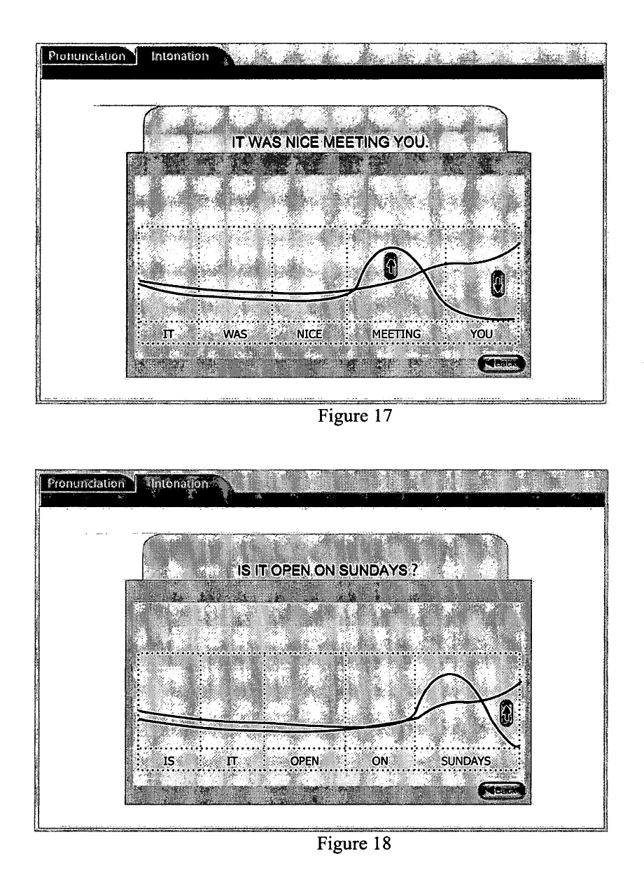

FIG. 17 shows the display screen providing feedback for intonation performance on a declarative sentence (“Intonation” is selected). The required and the analyzed patterns of Intonation are shown. The grid (vertical dotted lines) reflects the time alignment (a distance between two adjacent lines is relative to the word length, in terms of phonemes or syllables). The desired major sentence stress is presented by coloring the text corresponding to the stressed syllable, in this case, the text “MEET”. The arrows are display buttons that provide information on the type of the identified pronunciation error, the required correction, and the position (in term of syllables) of the error. Clicking on a display button will provide the related details (via an animation, for example, or by other means).

Similarly, FIG. 18 shows the display screen providing feedback for intonation performance on an interrogative sentence (“Intonation” is selected).

FIG. 19 shows the display screen providing feedback for a massive deviation from the expected utterance, recognized as “garbage”. As noted above, this provides for more efficient handling of such gross errors. As illustrated in the FIG. 2 flowchart, the system preferably does not subject garbage input to segmentation analysis.

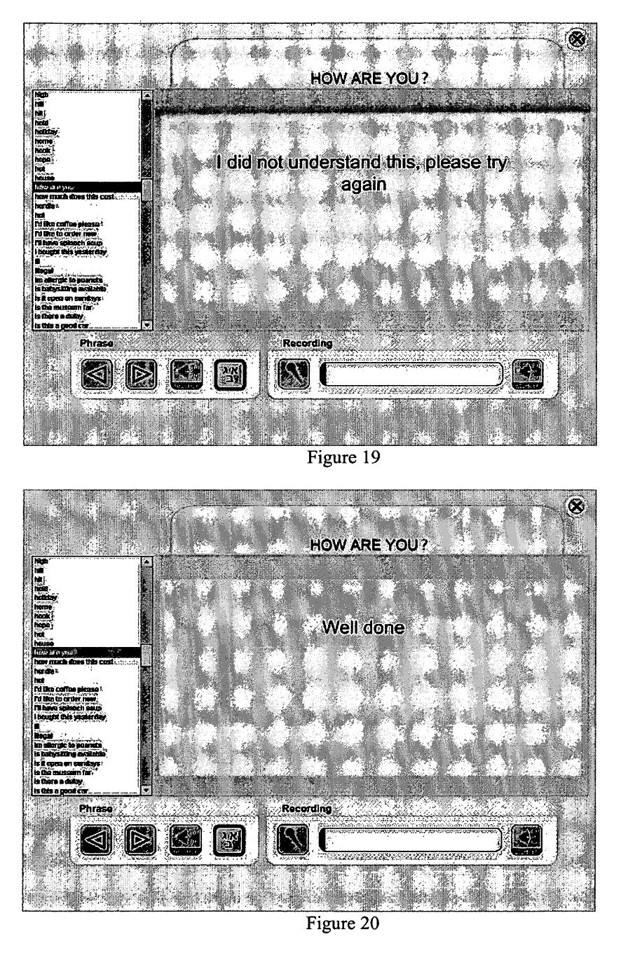

FIG. 20 shows the display screen providing feedback for a well-produced utterance. The display phrase “Well done” provides positive feedback to the user and encourages continued practice. The system then returns to the user prompt (input selection) processing (indicated in FIG. 2 as the start of the flowchart).

The present invention has been described above in terms of a presently preferred embodiment so that an understanding of the present invention can be conveyed. There are, however, many configurations for the system and application not specifically described herein but with which the present invention is applicable. The present invention should therefore not be seen as limited to the particular embodiment described herein, but rather, it should be understood that the present invention has wide applicability with respect to computer-assisted language instruction generally. All modifications, variations, or equivalent arrangements and implementations that are within the scope of the attached claims should therefore be considered within the scope of the invention.

We claim:

1. A computerized method of teaching spoken language skills comprising:
a. Receiving a user utterance into a computer system;
b. Analyzing the user utterance according to basic sound units;
c. Comparing the analyzed user utterance and desired utterance so as to detect any difference between the basic sound units comprising the user utterance and the basic sound units comprising the desired utterance;
d. Determining if a detected difference comprises an identifiable pronunciation error; and
e. Providing feedback to the user in accordance with the comparison.

2. The method of claim 1, wherein determining includes garbage analysis that determines if the user utterance is a grossly different utterance than the desired utterance.

3. The method of claim 1, wherein analyzing (b) includes mapping between the basic sound units of the desired utterance and the basic sound units of the user utterance, and wherein an identifiable pronunciation error comprises a user utterance having at least one of the following characteristics:
a. A basic sound unit of the user utterance, substantially the same as the corresponding basic sound unit of the desired utterance, that was produced differently but within an acceptance limit from the desired basic sound unit,
b. A basic sound unit of the user utterance that is different from the corresponding basic sound unit of the desired utterance,
c. A basic sound unit of the user utterance that is not present in the corresponding sound unit of the desired utterance, or
d. A basic sound unit of the desired utterance that is not present in the corresponding sound unit of the user utterance.

4. The method of claim 1, wherein providing feedback includes providing the user with a description of the mispronunciation.

5. The method of claim 1, wherein said basic sound units are phonemes.

6. The method of claim 4, where the identified basic sound unit in the user utterance can be either a basic sound unit of the desired utterance language or a basic sound unit of the user's native language.

7. The method of claim 1, wherein said feedback includes presentation of at least part of the utterance text corresponding to the user utterance basic sound units with identified production error.

8. The method of claim 1, wherein said feedback includes grading of the basic sound units of the user utterance, and grading is performed in accordance with an a priori expected performance level.

9. The method of claim 1, wherein feedback is provided in an hierarchical way, where any level above the lowest one includes feedback for multiple clusters where each cluster is composed of multiple clusters of the lower level, and the lowest level includes feedback for the basic sound units.

10. The method of claim 1, wherein analyzing includes assigning a stress level for at least one basic sound unit and, after comparison, determining if a detected difference is an identifiable stress error.

11. The method of claim 1, wherein analysis includes mapping of intonation to basic sound units and, after comparison, determining if a detected difference comprises an identifiable intonation error.

12. A computer system that provides instruction in spoken language skills, the computer system comprising:
a. an input device that receives a user utterance into the computer system;
b. a processor that analyzes the user utterance according to basic sound units, compares the analyzed user utterance and desired utterance so as to detect any difference between the basic sound units comprising the user utterance and the basic sound units comprising the desired utterance, determines if a detected difference comprises an identifiable pronunciation error, and provides feedback to the user in accordance with the comparison.

13. The system of claim 12, wherein the system determines detected differences by including a garbage analysis that determines if the user utterance is a grossly different utterance than the desired utterance.

14. The system of claim 12, wherein the system analyzes the user utterance by mapping between the basic sound units of the desired utterance and the basic sound units of the user utterance, and wherein an identifiable pronunciation error comprises a user utterance having at least one of the following characteristics:
a. A basic sound unit of the user utterance, same as the corresponding basic sound unit of the desired utterance, that was produced differently but within an acceptable distance from the desired basic sound unit,
b. A basic sound unit of the user utterance that is different from the corresponding basic sound unit of the desired utterance,
c. A basic sound unit of the user utterance that is not present in the corresponding sound unit of the desired utterance, or
d. A basic sound unit of the desired utterance that is not present in the corresponding sound unit of the user utterance.

15. The system of claim 12, wherein the system provides feedback by providing the user with a description of the mispronunciation.

16. The system of claim 12, wherein said basic sound units are phonemes.

17. The system of claim 15, where the identified basic sound unit in the user utterance can be either a basic sound unit of the desired utterance language or a basic sound unit of the user native language.

18. The system of claim 12, wherein said feedback includes presentation of at least part of the utterance text corresponding to the user utterance basic sound units with identified production error.

19. The system of claim 12, wherein said feedback includes grading of the basic sound units of the user utterance, and grading is performed in accordance with an a priori expected performance level.

20. The system of claim 12, wherein the feedback is provided in a hierarchical manner, where any level above the lowest one includes feedback for multiple clusters where each cluster is composed of multiple clusters of the lower level, and the lowest level includes feedback for the basic sound units

21. The system of claim 12, wherein the analysis includes assignment of a stress level for at least one basic sound unit and, after comparing, determining if a detected difference comprises an identifiable stress error.

22. The system of claim 12, wherein the analysis includes mapping of intonation to basic sound units and, after comparison, determining if a detected difference comprises an identifiable intonation error.
